(19) United States
(12) Patent Application Publication
(10) Pub. No.: US 2007/0190941 A1
(43) Pub. Date: Aug. 16, 2007

(54) TRANSMISSION OF DATA FOR MARKETING PURPOSES

(76) Inventors: Gene Fein, Lenox, MA (US); Edward Merritt, Lenox, MA (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/619,930

(22) Filed: Jan. 4, 2007

Related U.S. Application Data
(60) Provisional application No. 60/756,082, filed on Jan. 4, 2006.

(51) Int. Cl. H04B 7/00

(52) U.S. Cl. 455/41.2

(57) ABSTRACT

Briefly, in accordance with one or more embodiments, advertisement communications may be accessed via a telecommunication device.

### RELATED APPLICATION

The current patent application claims the benefit of U.S. Provisional Application No. 60/756,082, filed on Jan. 4, 2006, which is hereby incorporated by reference in its entirety.

### FIELD

This disclosure is related to advertisement communications accessed via a telecommunication device.

### BACKGROUND

Currently, advertising and marketing opportunities may be delivered to telecommunication devices capable of two-way communication via email, through the internet, via a phone call and/or via a port or Bluetooth connection. Once alerted to the marketing or advertising opportunity, the user may respond via a phone call, email or Bluetooth transmission. Currently, advertising may be sent to telecommunication devices via email, calling the user, or having the user access the advertiser via a port in the electronic device, either via wireless or Bluetooth connection.

### DESCRIPTION OF THE DRAWING FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a block diagram of a telecommunication device in accordance with one or more embodiments;

FIG. 2 is an illustration of multiple telecommunication devices in accordance with one or more embodiments;

FIG. 3 is an illustration of a telecommunication device in accordance with one or more embodiments;

FIG. 4 depicts a flow diagram illustrating an example procedure for operating a telecommunication device in accordance with one or more embodiments;

FIG. 5 depicts a flow diagram illustrating an example procedure for operating a telecommunication device in accordance with one or more embodiments;

FIG. 6 depicts a flow diagram illustrating an example procedure for operating a telecommunication device in accordance with one or more embodiments;

FIG. 7 depicts a flow diagram illustrating an example procedure for operating a telecommunication device in accordance with one or more embodiments; and

FIG. 8 depicts a flow diagram illustrating an example procedure for operating a telecommunication device in accordance with one or more embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of the claimed subject matter. It should also be noted that directions and references, for example, up, down, top, bottom, and so on, may be used to facilitate the discussion of the drawings and are not intended to restrict the application of the claimed subject matter. Therefore, the following detailed description is not to be taken in a limiting sense and the scope of the claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description that follow are presented in terms of algorithms, programs and/or symbolic representations of operations on data bits or binary digital signals within a computer memory, for example. These algorithmic descriptions and/or representations may include techniques used in the data processing arts to transfer the arrangement of a computing platform, such as a computer, a computing system, an electronic computing device, and/or other information handling system, to operate according to such programs, algorithms, and/or symbolic representations of operations. A program and/or process generally may be considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities. In addition, embodiments are not described with reference to any particular programming language. It will be appreciated that a variety of programming languages may be used to implement the teachings described herein.

Embodiments claimed may include one or more apparatuses for performing the operations herein. These apparatuses may be specially constructed for the desired purposes, or it may comprise a general purpose a computing platform, such as a computer, a computing system, an electronic computing device, and/or other information handling system, for example, selectively activated and/or reconfigured by a program stored in the device. The processes and/or displays presented herein are not inherently related to any particular computing platform and/or other apparatus. Various general purpose computing platforms may be used with programs in accordance with the teachings herein, or it may prove convenient to construct a more specialized computing platform to perform the desired method. The desired structure for a variety of these computing platforms will appear from the description below.

Embodiments claimed may include software capable of performing one or more of the operations described herein. Although the claimed subject matter is not limited in scope in this respect, one embodiment may be in hardware, such as implemented to operate on a device or combination of devices, whereas another embodiment may be in software. Likewise, an embodiment may be implemented in firmware, or as any combination of hardware, software, and/or firmware, for example. Likewise, although the claimed subject matter is not limited in scope in this respect, one embodiment may comprise one or more articles, such as a storage medium or storage media. This storage media may have stored thereon instructions that when executed by a computing platform, such as a computer, a computing system, an electronic computing device, and/or other information handling system, for example, may result in an embodiment of a method in accordance with the claimed subject matter being executed, for example.

In the following description and/or claims, the terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks including floppy disks, optical disks, CD-ROMs, magnetic-optical disks, read-only memories (ROMs), random access memories (RAMs), electrically programmable read-only memories (EPROMs), electrically erasable and/or programmable read-only memories (EEPROMs), flash memory, magnetic and/or optical cards, and/or any other type of media suitable for storing electronic instructions, and/or capable of being coupled to a system bus for a computing platform. However, these are merely examples of a storage medium, and the scope of the claimed subject matter is not limited in this respect.

In the following description and/or claims, the term “instructions” as referred to herein relates to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processor having a command set which includes the encoded commands. Such an instruction may be encoded in the form of a machine language understood by the processor. However, these are merely examples of an instruction, and the scope of the claimed subject matter is not limited in this respect.

Unless specifically stated otherwise, as apparent from the following discussion, it is appreciated that throughout this specification discussions utilizing terms such as processing, computing, calculating, selecting, forming, enabling, inhibiting, identifying, initiating, receiving, transmitting, determining, displaying, sorting, delivering, requesting, downloading, appending, making and/or the like refer to the actions and/or processes that may be performed by a computing platform, such as a computer, a computing system, an electronic computing device, and/or other information handling system, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, processes described herein, with reference to flow diagrams or otherwise, may also be executed and/or controlled, in whole or in part, by such a computing platform.

In the following description and/or claims, the term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In the following description and/or claims, the terms “coupled” and/or “connected”, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other.

Reference throughout this specification to “one embodiment” or “an embodiment” means that a particular feature, structure, or characteristic described in connection with the embodiment is included in at least one embodiment of the claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

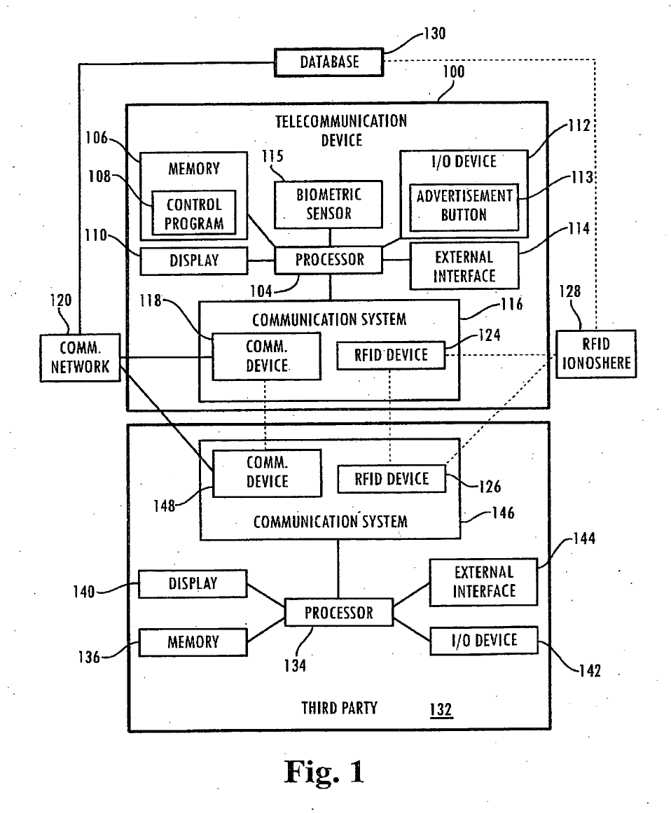

Referring to FIG. 1, a block diagram illustrates a telecommunication device 100 according to one or more embodiments, although the claimed subject matter is not limited in scope in this respect. Telecommunication device 100 may include more and/or fewer components than those shown in FIG. 1. However, generally conventional components may not be shown, for example, a battery, a bus, and so on.

Telecommunication device 100, as shown in FIG. 1 may be utilized to tangibly embody a computer program and/or graphical user interface by providing hardware components on which the computer program and/or graphical user interface may be executed. Such a computer program and/or machine readable instructions may be tangibly stored on a computer and/or machine readable medium such as a compact disk (CD), digital versatile disk (DVD), flash memory device, hard disk drive (HDD), and so on. As shown in FIG. 1, telecommunication device 100 may be controlled by processor 104, including one or more auxiliary processors (not shown). Processor 104 may comprise a central processing unit such as a microprocessor or microcontroller for executing programs, performing data manipulations, and controlling the tasks of telecommunication device 100. Auxiliary processors may manage input/output, perform floating point mathematical operations, manage digital signals, perform fast execution of signal processing algorithms, operate as a back-end processor and/or a slave-type processor subordinate to processor 104, operate as an additional microprocessor and/or controller for dual and/or multiple processor systems, and/or operate as a coprocessor and/or additional processor. Such auxiliary processors may be discrete processors and/or may be arranged in the same package as processor 104, for example, in a multicore and/or multithreaded processor; however, the scope of the claimed subject matter is not limited in these respects.

Communication with processor 104 may be implemented via a bus (not shown) for transferring information among the components of telecommunication device 100. A bus may include a data channel for facilitating information transfer between storage and other peripheral components of telecommunication device 100. A bus further may provide a set of signals utilized for communication with processor 104, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (GPIB), IEEE 696/S-100, and so on, although the scope of the claimed subject matter is not limited in this respect.

Other components of telecommunication device 100 may include, for example, memory 106, including one or more auxiliary memories (not shown). Memory 106 may provide storage of instructions and data for programs to be executed by processor 104, such as program 108, for example. Memory 106 may be, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, memory 106 may be, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic -based memory such as rewritable holographic storage utilizing the photorefractive effect in crystals, and/or the like; and/or a molecular-based memory such as polymer-based memories, and/or the like. Auxiliary memories may be utilized to store instructions and/or data that are to be loaded into memory 106 before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

Telecommunication device 100 further may include a display 110. Display 110 may comprise a video display adapter having components, including, for example, video memory, a buffer, and/or a graphics engine. Such video memory may be, for example, video random access memory (VRAM), synchronous graphics random access memory (SGRAM), windows random access memory (WRAM, and/or the like. Display 110 may comprise a cathode ray-tube (CRT) type display such as a monitor and/or television, and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth.

Telecommunication device 100 further may include one or more I/O devices 112. I/O device 112 may comprise one or more I/O devices 112 such as a keyboard, mouse, trackball, touchpad, joystick, track stick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, and/or the like. For example, I/O device 112 may comprise a microphone and/or a speaker. The microphone may be capable of converting sound waves into an electric current. The speaker may be capable of converting electrical signals into sounds loud enough to be heard. The microphone and/or speaker may be capable of converting verbal commands of a user into an electric current to trigger a response or action by telecommunication device 100.

Additionally or alternatively, I/O device 112 may comprise an advertisement button 113. Advertisement button 113 may be capable of interacting with advertisement communications. For example, activation of advertisement button 113 may request an advertisement communication be sent to telecommunication device 100. Additionally or alternatively, activation of advertisement button 113 may open an advertisement communication received by the telecommunication device 100. Further, activation of advertisement button 113 may request a purchase based on an advertisement communication received by the telecommunication device 100.

Additionally or alternatively, advertisement button 113 may display a logo. As used herein, the term “logo” includes but is not limited to a graphical representation of a generic service, a generic product, a branded service, a branded product, or the like. Further, telecommunication device 100 may include a mechanism to change the advertisement button 113 advertisement, marketing or emergency service provider message from one to another. For example, advertisement button 113 may comprise a display screen capable of displaying a first logo and/or replacing the first logo with a second logo. Accordingly, advertisement button 113 on telecommunication device 100 may be a generic brand or a specific printed brand and may be printed, changeable by virtue of the advertisement button 113 being a tiny display, such as an LED display, and/or the advertisement button 113 may not exist or be blank. Accordingly, telecommunication device 100 may include a quick, one-button solution for accessing the message of a marketer, sponsor or even emergency service provider. As discussed below, telecommunication device 100 may incorporate specifically programmed advertisement button 113 to facilitate transmission of data to and from sponsors, advertisers, marketers or any group or individual that desires such direct access.

Telecommunication device 100 further may include a bioemetric sensor 115. As used herein, the term “biometric sensor” may be any device capable of obtaining biometric identification information of a user. For example, biometric sensor 115 may comprise one or more of the following: a retinal sensor, a fingerprint sensor, or combinations thereof, and/or the like. Biometric identification information of a user obtained via biometric sensor 115 may be transmitted by telecommunication device 100 to verify a purchase. As discussed below, specific activity between the user and an advertiser or marketer, such as purchasing goods, may be facilitated and securely verified with the use of biometric technology.

Telecommunication device 100 further may include an external interface 114. External interface 114 may comprise one or more controllers and/or adapters to prove interface functions between multiple I/O devices 112. For example, external interface 114 may comprise a serial port, parallel port, universal serial bus (USB) port, and IEEE 1394 serial bus port, infrared port, network adapter, printer adapter, radio-frequency (RF) communications adapter, universal asynchronous receiver-transmitter (UART) port, and/or the like, to interface between corresponding I/O devices 112.

Telecommunication device 100 further may include a communication system 116. Communication system 116 may comprise one or more devices for hard wired communications and/or wireless communications, such as communication device 118. External interface 114 and/or communication device 118 may provide and/or receive analog and/or digital signals to communicate between telecommunication device 100 and external devices, networks, and/or information sources, such as communication network 120, for example. External interface 114 and/or communication device 118 may implement industry promulgated architecture standards, including, for example, Ethernet IEEE 802 type standards, such as IEEE 802.3 for broadband and/or baseband networks, IEEE 802.3z for Gigabit Ethernet, IEEE 802.4 for token passing bus networks, IEEE 802.5 for token ring networks, IEEE 802.6 for metropolitan area networks and/or the like, Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point-to-point protocol (SLIP/PPP), and so on.

Communication network 120 may comprise one or more of the following: a cellular phone network, a two-way radio network, an Internet network, a virtual private broadband network, a peer-to-peer voice over Internet protocol (IP) system, a local area network (LAN), a wireless local area network (WLAN), a wireless wide area network (WWAN), a wireless fidelity network (WiFi), a worldwide interoperability for microwave access network (WiMax), a multiple input multiple output antenna network (MIMO), a time division/domain multiple access network (TDMA), a code division multiple access network (CDMA), a Bluetooth network, an ultra wide band network (UWB), and/or a space division multiple access network (SDMA), the like, or combinations thereof, according to the particular application.

Communication system 116 m ay include a radio frequency identification device 124 (referred to as RFID device 124 hereinafter). RFID device 124 may be placed in the user's telecommunication device 100 either in the factory at the point of manufacture or as a retrofit in the future. As used herein, the term “RFID device” may be any device capable of transferring radio frequency identification information. Examples of RFID devices may include, but are not limited to, active RFID devices, passive RFID devices, the like, and/or combinations thereof, according to the particular application. RFID device 124 may communicate between telecommunication device 100 and external devices, networks, and/or information sources. Additionally or alternatively, RFID device 124 may be capable of communicating with a second RFID device 126 located adjacent or remote from telecommunication device 100 to transfer RFID information between RFID device 124 and RFID device 126. For example, RFID device 124 may include an RFID reader and/or an RFID tag, where RFID reader of RFID device 124 may retrieve RFID information from an RFID tag of RFID device 126 and/or where RFID tag of RFID device 124 may deliver RFID information to RFID reader of RFID device 126. RFID device 124 may be coupled to communication device 118 to be capable of communicating information, such as RFID information, via communication network 120. Additionally or alternatively, an RFID ionosphere 128 may be in communication with RFID device 126 so that telecommunication device 100 may be capable of communicating information, such as RFID information via RFID device 126 and RFID ionosphere 128. As used herein, the term “RFID ionosphere” may be any system capable of communicating RFID information.

For example, third party information may be transmitted by RFID signal via RFID device 126 and may be obtained via RFID device 124 connected to telecommunication device 100. Additionally or alternatively, this third party information may be used to change logos on advertisement button 113. For example, a first logo may be displayed via a display screen of the advertisement button 113, and the first logo may be replaced with a second logo based at least in part on the third party information obtained from the RFID device 124. As discussed below, specific activity between the user and an advertiser or marketer, such as purchasing goods, may be facilitated and securely verified with the use of RFID technology.

Telecommunication device 100 further may communicate with a database 130. For example, telecommunication device 100 may communicate with database 130 via external interface 114 and/or communication system 116 to supply information and/or data to telecommunication device 100. Additionally or alternatively, telecommunication device 100 may communicate with database 130 via RFID device 124 through RFID ionosphere 128. Additionally or alternatively, telecommunication device 100 may communicate with database 130 via communication device 118 through communication network 120.

Telecommunication device 100 may communicate in one or more various ways with a third party 132. Third party 132 may comprise many components similar to those described above with respect to telecommunication device 100. For example, third party 132 may comprise one or more of the following: processor 134, memory 136, display 140, I/O device 142, external interface 144, communication system 146, communication device 148, and/or RFID device 126. A description of the operation of these components of third party 132 will be understood from the corresponding description above with respect to telecommunication device 100.

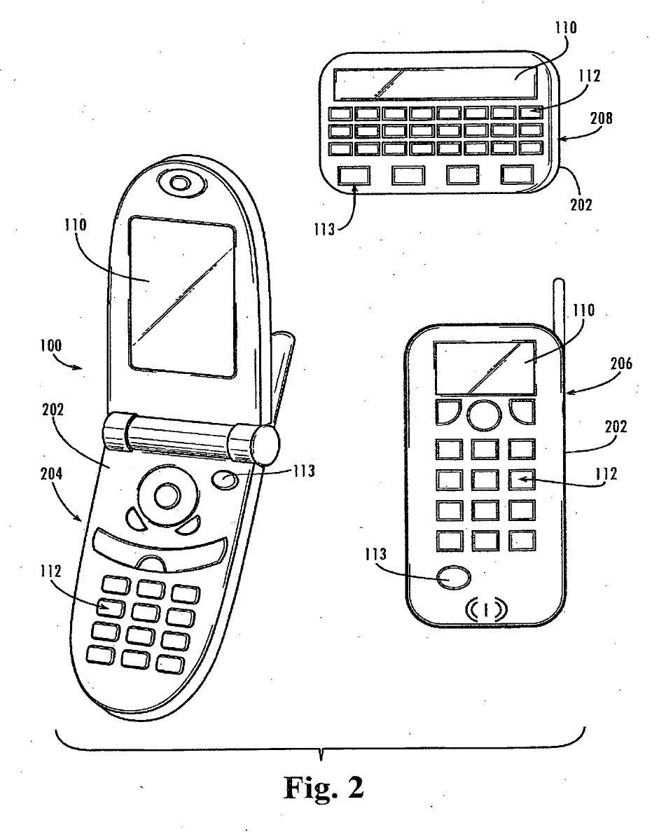

Referring to FIG. 2, an illustration of multiple telecommunication devices 100 according to one or more embodiments is shown, although the claimed subject matter is not limited in scope in this respect. Telecommunication device 100 may include more and/or fewer components than those shown in FIG. 2. However, generally conventional components may not be shown, for example a battery, a processor, and so on. Illustrated in FIG. 2, telecommunication device 100 may include a housing 202 that may be capable of being personally portable, such as, for example, being carried and/or worn by a user, although the claimed subject matter is not limited in scope in this respect. As used herein, the term “personally portable” comprises, but is not limited to, being capable of being carried on and/or by a person. Housing 202 may comprise any number of either portable or stationary, durable or disposable, wireless or wired electronic two way communication devices, such as, for example, a cellular phone 204, home phone 206, a portable hand held device 208 (such as a PDA, a Blackberry, a Treo or the like), a phone enabled media player, a pager, a television, a computer, a hybrid communication device, or combinations thereof, and/or the like, although the claimed subject matter is not limited in scope in this respect.

Housing 202 may be capable of housing all or a portion of telecommunication device 100, such as, for example, display 110, I/O device 112 and/or advertisement button 113, or combinations thereof, and/or the like, according to the particular application. As discussed above, advertisement button 113 may display a logo including but not limited to a graphical representation of a generic service, a generic product, a branded service, a branded product, or the like. For example, advertisement button 113 may display a logo such as a generic button for “Free Net”. Additionally or alternatively, advertisement button 113 may comprise a display screen capable of displaying a first logo and/or replacing the first logo with a second logo. For example, advertisement button 113 may comprise a changeable LED screen to display different generic or specific sponsor logos or images. Additionally or alternatively, advertisement button 113 may flash to alert users to the advertisement button 113 and /or to alert users of a subsequent message.

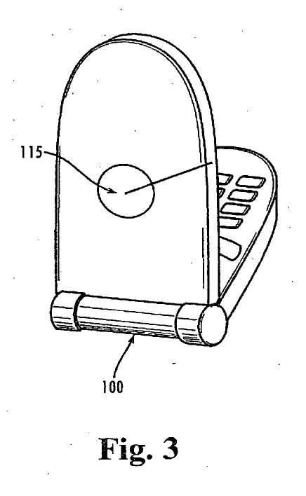

Referring to FIG. 3, an illustration of telecommunication device 100 according to one or more embodiments is shown, although the claimed subject matter is not limited in scope in this respect. Telecommunication device 100 may include more and/or fewer components than those shown in FIG. 3. However, generally conventional components may not be shown, for example a battery, a processor, and so on. Illustrated in FIG. 3, telecommunication device 100 may include a biometric sensor 115. For example, biometric sensor 115 may be located on the back of cell phone 204 or in any other suitable location on cell phone 204, although the claimed subject matter is not limited in scope in this respect.

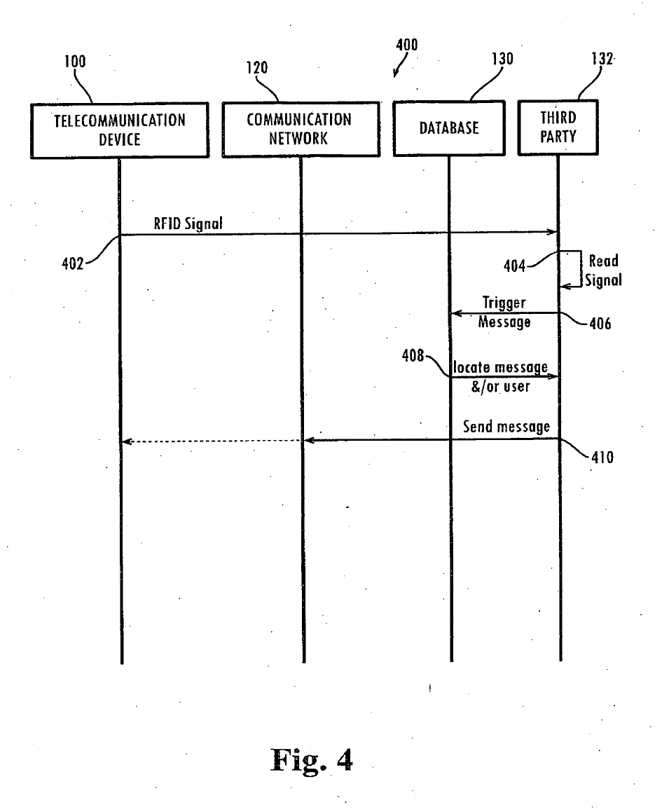

Referring now to FIG. 4, a flow diagram illustrates an example procedure 400 for operating telecommunication device 100 in accordance with one or more embodiments, although the claimed subject matter is not limited in scope in this respect. Procedure 400 illustrated in FIG. 4 may be used to transmit an RFID signal from telecommunication device 100, for example, although the claimed subject matter is not limited in this respect. Additionally, although procedure 400, as shown in FIG. 4, comprises one particular order of blocks, the order in which the blocks are presented does not necessarily limit the claimed subject matter to any particular order. Likewise, intervening blocks shown in FIG. 4 and/or additional blocks not shown in FIG. 4 may be employed and/or blocks shown in FIG. 4 may be eliminated, without departing from the scope of the claimed subject matter.

Procedure 400 depicted in FIG. 4 may in alternative embodiments be implemented in software, hardware, and/or firmware, and may comprise discrete operations. As illustrated, procedure 400 starts at block 402 where telecommunication device 100 may transmit an RFID signal to third party 132. At block 404, third party 132 may read the RFID signal via an RFID device 126 (see FIG. 1). For example, a retail location may read the RFID signal of a user passing nearby. At block 406, having read the RFID signal from telecommunication device 100, third party 132 may trigger the message sending process from processor 134 (see FIG. 1) of third party 132 to database 130. At block 408, database 130 may locate the message and/or user and sends this information to processor 134 (see FIG. 1) of third party 132. At block 410, processor 134 (see FIG. 1) of third party 132 may send the message to telecommunication device 100 via communication network 120, or to telecommunication device 100 directly from the third party message sender 132 with a simultaneous or subsequent transmission to the communication network 120 for transaction data storage and/or processing.

For example, the user may be contacted by a message from third party 132 delivered by virtue of RFID device 126 from the third party message sender 132 when the RFID device 126 detects an RFID signal transmitted by RFID device 124 in the user telecommunication device 100. For instance, the RFID signal from the user may be transmitted as the user walks by a business or location which the third party message deliverer 132 has an RFID reader and/or transmitter of RFID device 126. RFID device 126 may deliver its own message or trigger a message to be delivered from an auxiliary third party (not shown). The message may be delivered straight from the third party 132 or via communication network 120. RFID device 126 may charge any auxiliary third party message sender (not shown) a fee, which may be administered through a central system or directly between the parties.

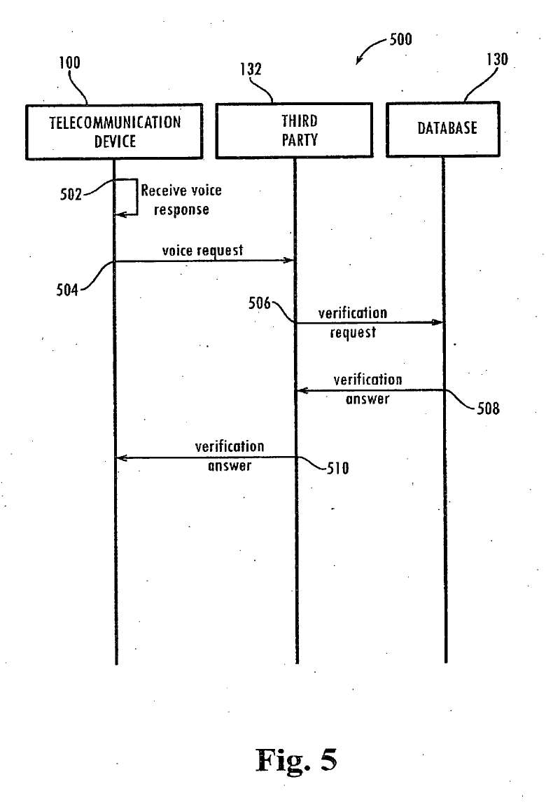

Referring now to FIG. 5, a flow diagram illustrates an example procedure 500 for operating telecommunication device 100 in accordance with one or more embodiments, although the claimed subject matter is not limited in scope in this respect. Procedure 500 illustrated in FIG. 5 may be used to transmit a voice response or request to the third party network from telecommunication device 100, for example, although the claimed subject matter is not limited in this respect. As illustrated, procedure 500 starts at block 502 where telecommunication device 100 may receive a voice response or request from a user in response to an advertisement communication from third party 132. For example, the voice signal of the user may be received by a microphone of I/O device 112 (see FIG. 1) of telecommunication device 100. At block 504, the request may be transmitted to processor 134 (see FIG. 1) of third party 132 for verification. At block 506, third party 132 may transmit a verification request to database 130. At block 508, database 130 may match the voice response or request from user, secure the transaction, and/or transmit a verification answer back to processor 134 (see FIG. 1) of third party 132. At block 510, processor 134 (see FIG. 1) of third party 132 may transmit the verification answer back to telecommunication device 100 in voice and/or data form.

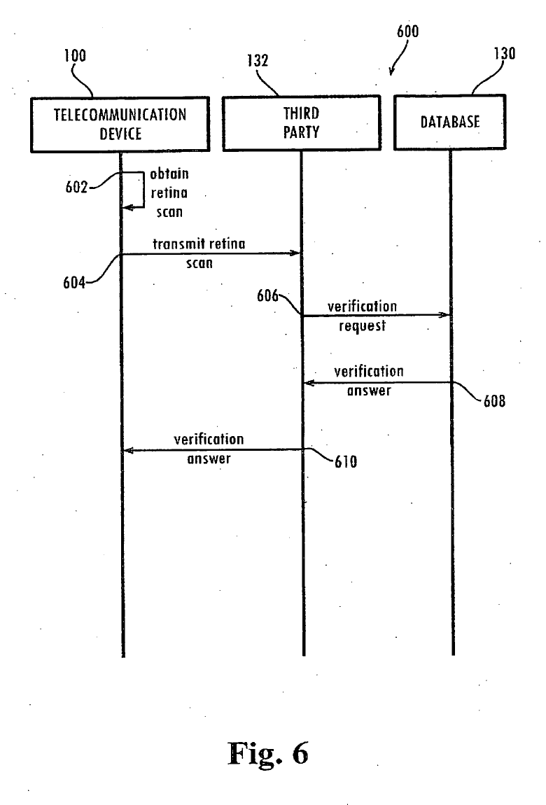

Referring now to FIG. 6, a flow diagram illustrates an example procedure 600 for operating telecommunication device 100 in accordance with one or more embodiments, although the claimed subject matter is not limited in scope in this respect. Procedure 600 illustrated in FIG. 6 may be used to securely verify a transaction by the network using a retinal scan of the user from telecommunication device 100, for example, although the claimed subject matter is not limited in this respect. As illustrated, procedure 600 starts at block 602 where telecommunication device 100 may obtain an image of the retina of a user using a biometric sensor 115 (see FIG. 1). For example, telecommunication device 100 may include a camera type and/or scanning type biometric sensor 115 (see FIG. 1) capable of functioning as a retinal scanner. At block 604, the retina scan may be transmitted to processor 134 (see FIG. 1) of third party 132 for verification. At block 606, third party 132 may transmit a verification request to database 130. At block 608, database 130 may transmit a verification answer of whether the scan is that of the user, is not the user, or is undetermined back to processor 134 (see FIG. 1) of third party 132. At block 610, processor 134 (see FIG. 1) of third party 132 may transmit the verification answer back to telecommunication device 100 in voice and/or data form.

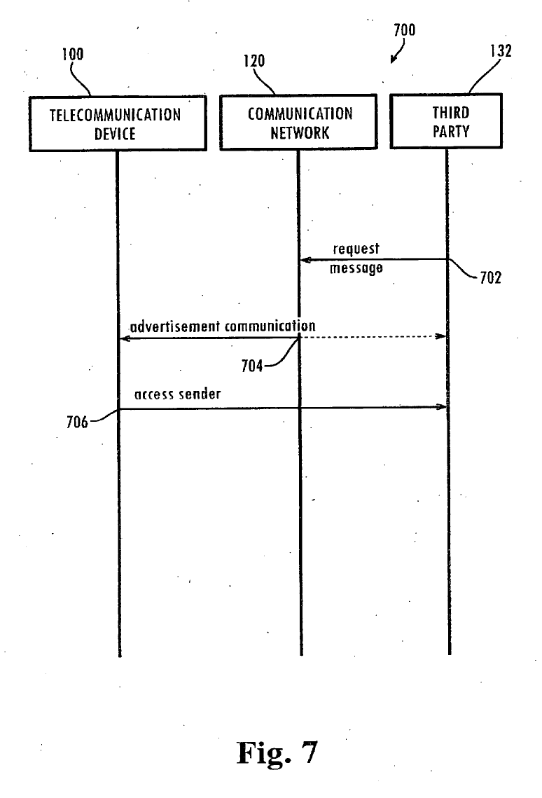

Referring now to FIG. 7, a flow diagram illustrates an example procedure 700 for operating telecommunication device 100 in accordance with one or more embodiments, although the claimed subject matter is not limited in scope in this respect. Procedure 700 illustrated in FIG. 7 may be used to receive one or more advertisement communications from third party 132 and/or contact a third party 132 via telecommunication device 100, for example, although the claimed subject matter is not limited in this respect. As illustrated, procedure 700 starts at block 702 where third party 132 may request the controller/scheduler of communication network 120 send a certain kind of message to select user(s). At block 704, the controller/scheduler of communication network 120 may send the requested advertisement communication directly to the user via telecommunication device 100. Alternatively or additionally, controller/scheduler of communication network 120 may transmit a schedule contact information message to third party 132 to permit third party 132 to send the requested advertisement communication directly to the user via telecommunication device 100. At block 706, the user via telecommunication device 100 may access third party 132 based on the advertisement communication. For example, the user may access third party 132 directly through activating advertisement button 113 (see FIG. 1); or the user may access third party 132 indirectly via communication network 120 by activating advertisement button 113 (see FIG. 1); or the user may respond to the third party 132 directly or through the communication network 120 via a response function designated by the third party 132 or network control system using the telecommunication device 100 as a phone, a pager, an RFID device, and/or via internet transmission, or combinations thereof, and/or the like, although the claimed subject matter is not limited in scope in this respect.

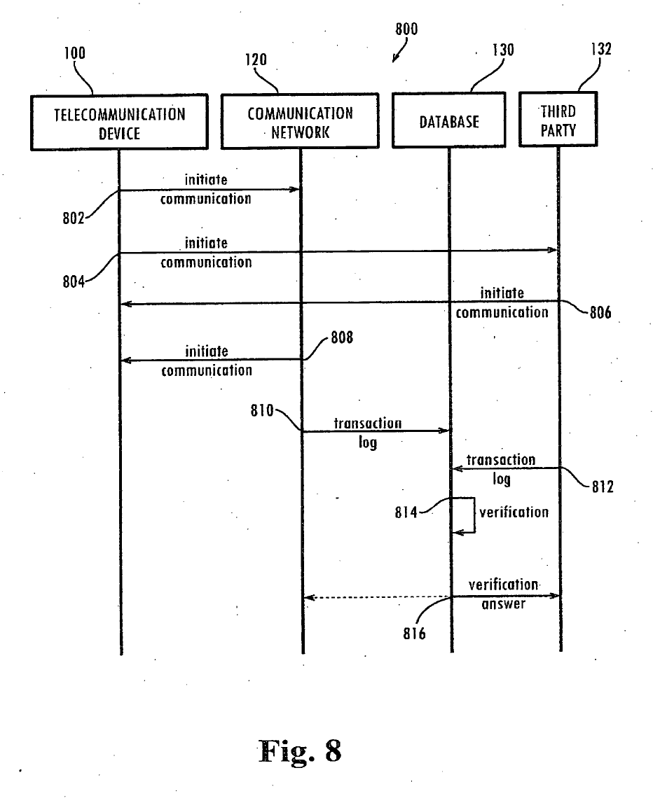

Referring now to FIG. 8, a flow diagram illustrates an example procedure 800 for operating telecommunication device 100 in accordance with one or more embodiments, although the claimed subject matter is not limited in scope in this respect. Procedure 800 illustrated in FIG. 8 may be used to initiate the flow of communications either from telecommunication device 100 to the controller/scheduler of communication network 120 and/or from telecommunication device 100 to third party 132, for example, although the claimed subject matter is not limited in this respect. As illustrated, procedure 800 starts at block 802 where telecommunication device 100 may initiate communications to controller/scheduler of communication network 120. Additionally or alternatively, at block 804, telecommunication device 100 may initiate communications to third party 132. Additionally or alternatively, at block 806, third party 132 may initiate communications to telecommunication device 100. Additionally or alternatively, at block 808, controller/scheduler of communication network 120 may initiate communications to telecommunication device 100. At block 810, controller/scheduler of communication network 120 may log transactions into the database 130. At block 812, third party 132 may log transactions into the database 130. At block 814, database 130 may locate content or data for verification. At block 816, database 130 may transmit a verification answer to controller/scheduler of communication network 120 and/or third party 132 for possible transmission to telecommunication device 100.

Referring now to FIGS. 1-8, users of telecommunication device 100 may be incentivized with free service and/or a free device in exchange for viewing, and in some cases, replying to third party messages from advertisers, marketers, promotional messages or public service announcements. For example, telecommunication device 100 may receive one or more advertisement communications which may at least partially subsidizing the cost of telecommunication access based at least in part on a user's response to the one or more advertisement communications. The cost of telecommunication access may comprise one or more of the following: the cost of a telecommunications device, or the cost of telecommunications service, or combinations thereof.

As discussed above, telecommunication device 100 and/or communication service plan for access to communication network 120 may be offered separately and may be utilized separately or with existing devices or communications networks. For example, the user may be given a free telecommunication device 100 and free calling service for accessing the communication network 120. Additionally or alternatively, the user may be given a free calling service to use with an existing telecommunication device 100 for accessing the communication network 120. Additionally or alternatively, the user may be given a free telecommunication device 100 to use with an existing calling service for accessing the communication network 120. Additionally or alternatively, the user may access the communication network 120 with an existing telecommunication device 100 and existing service in place.

Accordingly, telecommunication device 100 may include a paid, subsidized or free communication device, as well as paid, subsidized or free service. Such service may be provided in exchange for those users submitting to receiving and possibly being obligated to return various messages received from third parties 132 who arrange for advertising, marketing, promotional or public service messages to be made available over telecommunication device 100. Such third party 132 access to the user may be made directly between the third party 132 and the user or via a communication network 120 that parses access to users based upon the accepted offers of third parties seeking to deliver messages to users. In addition, the users may be required to return all, some or no third party 132 messages. Advertisement messages may be required to be returned by the user either immediately, during a proscribed period of time, or never in order to gain access to the free pr subsidized calling network. Users may have the option to switch to a paid calling system that would limit some or all access to the third party 132 message delivery network. Users may be updated regarding their access to free or subsidized calling minutes or usage units via telecommunication device 100. The returning of certain third party 132 messages or proscribed amounts of third party 132 messages may entitle the users to continued free or subsidized usage of telecommunication device 100, or decreased usage of telecommunication device 100, or no usage of telecommunication device 100. By keeping the user apprised of their rights to utilize the calling or messaging system the user may be incentivized to engage more quickly or willingly in the receiving and returning of third party 132 messages. If the user's access to the system is denied due to user failure to reply or screen third party 132 messages as required, then the user may be given a certain amount of time to return third party messages before being removed from the system and possibly being charged a fee or forfeiture of a deposit that was paid at the time of acquisition of telecommunication device 100 or entry to the communication network 120 with an existing device.

As discussed above, advertisers and marketers may use a free or subsidized service and/or telecommunication device 100 to launch a platform for future marketing, advertising, shopping and programming and public service systems. Accordingly, a low cost method to have access to phone service for consumers who may not have the regular resource or credit to do so may be made available. Additionally or alternatively, telecommunication device 100 may operate within a two way network with participating sponsors also being given the number to send messages or other content to users availing themselves of the “free communication network”.

As discussed above, the one or more advertisement communications may be sent to telecommunication device 100 based on a request from the user, such as by activating advertisement button 113, such as by opening the one or more advertisement communications and/or making a purchase based on the one or more advertisement communications. Further, one or more advertisement communications may be sent to telecommunication device 100 based on RFID signals from telecommunication device 100. Validation of a purchase by a user may be based on biometric identification information of the user obtained via telecommunication device 100.

For example, the users of telecommunication devices 100 may contact the third party message senders 132 via outgoing messages from telecommunication device 100, and/or be contacted by the third party message senders via incoming message to telecommunication device 100. The third party message senders 132 may also be given contact information for telecommunication device 100 or other contact information to send messages directly to the user even when the user has not requested that the message be sent. Purchasing, billing and shipping information may be stored on telecommunication device 100 from information acquired by the purveyor of telecommunication device 100 at the point of purchase and/or may be transmitted to a seller utilizing the messaging system enabling the user to make a purchase or response to a marketing opportunity via a single touch of advertisement button 113, or voice command, or RFID swipe. The seller may then securely verify the transaction via input of pin code, voice activated pin code, voice call, email or text message, retinal scan verification via phone camera or thumbprint verification using the telecommunication device 100 display surface 110 and/or camera 115. The verification info may then be securely matched within a database 130 containing the user's information which was created at the time of acquisition of telecommunication device 100, or at a later date, by the user. There may be one user on the system available to send messages to or billions of users available to send messages to. Database technology may be utilized whereby users may be given access to or sent specific messages based upon preferences that they have input into the system, either at the time of device purchase, or at a later date. Database technology containing user history with telecommunication device 100, or other user history, capable of being updated in real time, and/or available via the consent of the user, may be parsed and analyzed by a specific third party 132 or a centralized third party network, to select new messages to send to the user.

Upon the pressing of the advertisement button 113 by the user, or via voice activation, a call or email will be placed directly to the third party 132 who has arranged for advertisement button 113 to be programmed to a desired number which can direct the user of the device to a specific message, including marketing messages, direct sale messages, public service messages, etc. The third party 132 message delivered may also be given access to place incoming unsolicited or requested messages to the user of telecommunication device 100 or service. The user of the telecommunication device 100 may then transact business with third party 132 at the choice of the user. These advertisement messages may take the form of video, audio, text or any combination thereof. These messages may be rotated by one or an unlimited amount of third party message senders 132.

In the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

What is claimed is:

1. An apparatus, comprising:
a telecommunication device; and
an advertisement button connected to the telecommunication device, wherein the advertisement button is dedicated to interact with advertisement communications.

2. The apparatus of claim 1, wherein the advertisement button comprises a logo displayed thereon.

3. The apparatus of claim 1, wherein the advertisement button comprises a display screen capable of displaying one or more logos thereon.

4. The apparatus of claim 1, further comprising an RFID device connected to the telecommunication device, wherein the RFID device is capable of obtaining third party information transmitted by RFID signal, and wherein the advertisement button comprises a display screen capable of displaying one or more logos thereon based at least in part on third party information obtained from the RFID device.

5. The apparatus of claim 1, further comprising a biometric sensor connected to the telecommunication device, wherein the biometric sensor is capable of obtaining biometric identification information of a user.

6. The apparatus of claim 1, wherein the advertisement button is dedicated to interact with advertisement communications by requesting an advertisement communication be sent to the telecommunication device upon activation of the advertisement button.

7. The apparatus of claim 1, wherein the advertisement button is dedicated to interact with advertisement communications by opening an advertisement communication received by the telecommunication device upon activation of the advertisement button.

8. The apparatus of claim 1, wherein the advertisement button is dedicated to interact with advertisement communications by requesting a purchase based on an advertisement communication received by the telecommunication device upon activation of the advertisement button.

9. A method, comprising:
communicating via a telecommunication device; and
interacting with advertisement communications via a dedicated advertisement button connected to the telecommunication device.

10. The method of claim 9, further comprising displaying a logo via the advertisement button.

11. The method of claim 9, further comprising displaying a first logo via a display screen of the advertisement button, and replacing the first logo with a second logo via the display screen.

12. The method of claim 9, further comprising obtaining third party information transmitted by RFID signal via an RFID device connected to the telecommunication device, displaying a first logo via a display screen of the advertisement button, and replacing the first logo with a second logo via the display screen based at least in part on third party information obtained from the RFID device.

13. The method of claim 9, further comprising obtaining biometric identification information of a user via a biometric sensor connected to the telecommunication device, and transmitting the biometric identification information to verify a purchase.

14. The method of claim 9, further comprising requesting an advertisement communication be sent to the telecommunication device upon activation of the advertisement button.

15. The method of claim 9, further comprising opening an advertisement communication received by the telecommunication device upon activation of the advertisement button.

16. The method of claim 9, further comprising requesting a purchase based on an advertisement communication received by the telecommunication device upon activation of the advertisement button.

17. An article of manufacture, comprising: a storage medium having stored thereon instructions, that, if executed, result in:
communicating via a telecommunication device; and
interacting with advertisement communications via a dedicated advertisement button connected to the telecommunication device.

18. The article of claim 17, wherein the instructions, if executed, further result in displaying a logo via the advertisement button.

19. The article of claim 17, wherein the instructions, if executed, further result in displaying a first logo via a display screen of the advertisement button, and replacing the first logo with a second logo via the display screen.

20. The article of claim 17, wherein the instructions, if executed, further result in obtaining third party information transmitted by RFID signal via an RFID device connected to the telecommunication device, displaying a first logo via a display screen of the advertisement button, and replacing the first logo with a second logo via the display screen based at least in part on third party information obtained from the RFID device.

21. The article of claim 17, wherein the instructions, if executed, further result in obtaining biometric identification information of a user via a biometric sensor connected to the telecommunication device, and transmitting the biometric identification information to verify a purchase.

22. The article of claim 17, wherein the instructions, if executed, further result in requesting an advertisement communication be sent to the telecommunication device upon activation of the advertisement button.

23. The article of claim 17, wherein the instructions, if executed, further result in opening an advertisement communication received by the telecommunication device upon activation of the advertisement button.

24. The article of claim 17, wherein the instructions, if executed, further result in requesting a purchase based on an advertisement communication received by the telecommunication device upon activation of the advertisement button.

25. A method, comprising:
sending one or more advertisement communications to a telecommunication device; and
at least partially subsidizing the cost of telecommunication access based at least in part on a user's response to the one or more advertisement communications.

26. The method of claim 25, wherein the sending of the one or more advertisement communications to the telecommunication device is based on a request from the user.

27. The method of claim 25, further comprising receiving a request activated via an advertisement button of the telecommunication device, and wherein the sending the one or more advertisement communications to the telecommunication device is based at least in part on the request activated via the advertisement button.

28. The method of claim 25, further comprising receiving an RFID signal from the telecommunication device, and wherein the sending the one or more advertisement communications to the telecommunication device is based at least in part on the RFID signal.

29. The method of claim 25, further comprising receiving biometric identification information of the user, and validating a purchase by a user based at least in part on the biometric identification information of the user.

30. The method of claim 25, wherein the cost of telecommunication access comprises one or more of the following: the cost of a telecommunications device, or the cost of telecommunications service, or combinations thereof.

31. The method of claim 25, wherein the user's response comprises opening the one or more advertisement communications.

32. The method of claim 25, wherein the user's response comprises making a purchase based on the one or more advertisement communications.

33. An article of manufacture, comprising: a storage medium having stored thereon instructions, that, if executed, result in:
sending one or more advertisement communications to a telecommunication device; and
at least partially subsidizing the cost of telecommunication access based at least in part on a user's response to the one or more advertisement communications.

34. The article of claim 33, wherein the sending of the one or more advertisement communications to the telecommunication device is based on a request from the user.

35. The article of claim 33, wherein the instructions, if executed, further result in receiving a request activated via an advertisement button of the telecommunication device, and wherein the sending the one or more advertisement communications to the telecommunication device is based at least in part on the request activated via the advertisement button.

36. The article of claim 33, wherein the instructions, if executed, further result in receiving an RFID signal from the telecommunication device, and wherein the sending the one or more advertisement communications to the telecommunication device is based at least in part on the RFID signal.

37. The article of claim 33, wherein the instructions, if executed, further result in receiving biometric identification information of the user, and validating a purchase by a user based at least in part on the biometric identification information of the user.

38. The article of claim 33, wherein the cost of telecommunication access comprises one or more of the following: the cost of a telecommunications device, or the cost of telecommunications service, or combinations thereof.

39. The article of claim 33, wherein the user's response comprises opening the one or more advertisement communications.

40. The article of claim 33, wherein the user's response comprises making a purchase based on the one or more advertisement communications.

41. An apparatus, comprising:
means for sending one or more advertisement communications to a telecommunication device; and
means for at least partially subsidizing the cost of telecommunication access based at least in part on a user's response to the one or more advertisement communications.

42. The apparatus of claim 41, wherein the means for sending of the one or more advertisement communications to the telecommunication device is based on a request from the user.

43. The apparatus of claim 41, further comprising means for receiving a request activated via an advertisement button of the telecommunication device, and wherein the means for sending the one or more advertisement communications to the telecommunication device is based at least in part on the request activated via the advertisement button.

44. The apparatus of claim 41, further comprising means for receiving an RFID signal from the telecommunication device, and wherein the means for sending the one or more advertisement communications to the telecommunication device is based at least in part on the RFID signal.

45. The apparatus of claim 41, further comprising means for receiving biometric identification information of the user, and means for validating a purchase by a user based at least in part on the biometric identification information of the user.

46. The apparatus of claim 41, wherein the cost of telecommunication access comprises one or more of the following: the cost of a telecommunications device, or the cost of telecommunications service, or combinations thereof.

47. The apparatus of claim 41, wherein the user's response comprises opening the one or more advertisement communications.

48. The apparatus of claim 41, wherein the user's response comprises making a purchase based on the one or more advertisement communications.
